(19) United States
(12) Patent Application Publication
(10) Pub. No.: US 2015/0058776 A1
(43) Pub. Date: Feb. 26, 2015

(54) PROVIDING KEYBOARD SHORTCUTS MAPPED TO A KEYBOARD

(71) Applicants: Eric Liu, Redwood City, CA (US); Seung Wook Kim, Cupertino, CA (US); Stefan J. Marti, Oakland, CA (US)

(72) Inventors: Eric Liu, Redwood City, CA (US); Seung Wook Kim, Cupertino, CA (US); Stefan J. Marti, Oakland, CA (US)

(73) Assignee: QUALCOMM Incorporated, San Diego, CA (US)

(21) Appl. No.: 14/355,026

(22) PCT Filed: Nov. 11, 2011
(86) PCT No.: PCT/US2011/060364

§ 371 Date: Nov. 6, 2014

(51) Int. Cl. G06F 3/0481; G06F 3/0488; G06F 3/0484

(52) U.S. Cl. CPC G06F 3/0481; G06F 3/04842; G06F 3/0488
USPC 715/771

(57) ABSTRACT

Example embodiments relate to the provision of keyboard shortcuts that are mapped to a physical keyboard. In example embodiments, a user interface including a plurality of selectable UI elements is outputted. A plurality of keyboard shortcuts may then be outputted, such that each keyboard shortcut corresponds to a key on a physical keyboard and the shortcuts are spatially arranged in a layout corresponding to a layout of the keyboard. A selection of a particular key may then be received and, in response, the UI element positioned at the location of the keyboard shortcut corresponding to the selected key may be activated.

### BACKGROUND

User interfaces enable a user of a computing device to provide input to the device using various techniques. For example, typical desktop computer interfaces allow a user to select interface elements using a cursor controlled by a mouse, while providing text input using a keyboard. As an alternative, some interfaces enable a user to provide input in the form of touch, such that the user may directly manipulate the user interface objects using his or her fingers.

### BRIEF DESCRIPTION OF THE DRAWINGS

The following detailed description references the drawings, wherein:

FIG. 1 is a diagram of an example apparatus for displaying keyboard shortcuts that are spatially mapped to a physical keyboard;

FIG. 2 is a block diagram of an example apparatus including a computing device that displays keyboard shortcuts that are spatially mapped to a physical keyboard;

FIG. 3A is a block diagram of an example apparatus for displaying keyboard shortcuts by an operating system of a computing device;

FIG. 3B is a block diagram of an example apparatus for displaying keyboard shortcuts by an application executing on a computing device;

FIG. 4 is a flowchart of an example method for providing keyboard shortcuts and responding to user selection of the keyboard shortcuts;

FIG. 5 is a flowchart of an example method for providing keyboard shortcuts in multiple regions of an interface and for responding to user selection of the keyboard shortcuts;

FIG. 6A is a diagram of an example user interface including keyboard shortcuts arranged in rows and columns that correspond to a physical keyboard; and

FIG. 6B is a diagram of an example user interface including keyboard shortcuts arranged within two regions in rows and columns that correspond to a physical keyboard.

### DETAILED DESCRIPTION

As detailed above, user interfaces enable a user to provide input to a computer using a mouse, keyboard, touch, or other input technique. As a user gains familiarity with a particular interface, he or she may desire to make the interaction more efficient by utilizing keyboard shortcuts overlaid on the interface. Similarly, the user may desire to use keyboard shortcuts when he or she is away from a touch display and/or mouse, such that the user may fully interact with the interface from a distance.

Example embodiments disclosed herein allow for highly-efficient interactions with a user interface by providing keyboard shortcuts that are spatially mapped to the layout of the keyboard. For example, in some implementations, a computing device may initially display a user interface (UI) including a plurality of selectable UI elements. The device may then display a plurality of keyboard shortcuts overlaid on the user interface. Each keyboard shortcut may correspond to a respective key on a physical keyboard and, in addition, the plurality of keyboard shortcuts may be spatially arranged in a layout corresponding to a layout of the physical keyboard. The computing device may further receive a selection of a particular key on the physical keyboard. In response, the computing device may activate the selectable UI element positioned at a location of the keyboard shortcut corresponding to the selected key.

In this manner, example embodiments disclosed herein provide keyboard shortcuts that are mapped to the layout of the keyboard, such that the user can quickly activate shortcuts based on their location on the screen without memorizing shortcuts for each application. Similarly, users familiar with touch typing may quickly activate shortcuts without looking at the keyboard, thereby significantly increasing the efficiency of their interaction. In addition, the user may save time by minimizing the need to switch between typing on the keyboard and interacting with a mouse or touchscreen. Furthermore, in touch-based environments, the user may remotely control the touch interface from a location physically removed from the display (e.g., from a sofa) without the need to actually touch the display. Advantageously, because any keyboard may be used to implement the keyboard shortcuts, each of the described benefits may be obtained without additional hardware.

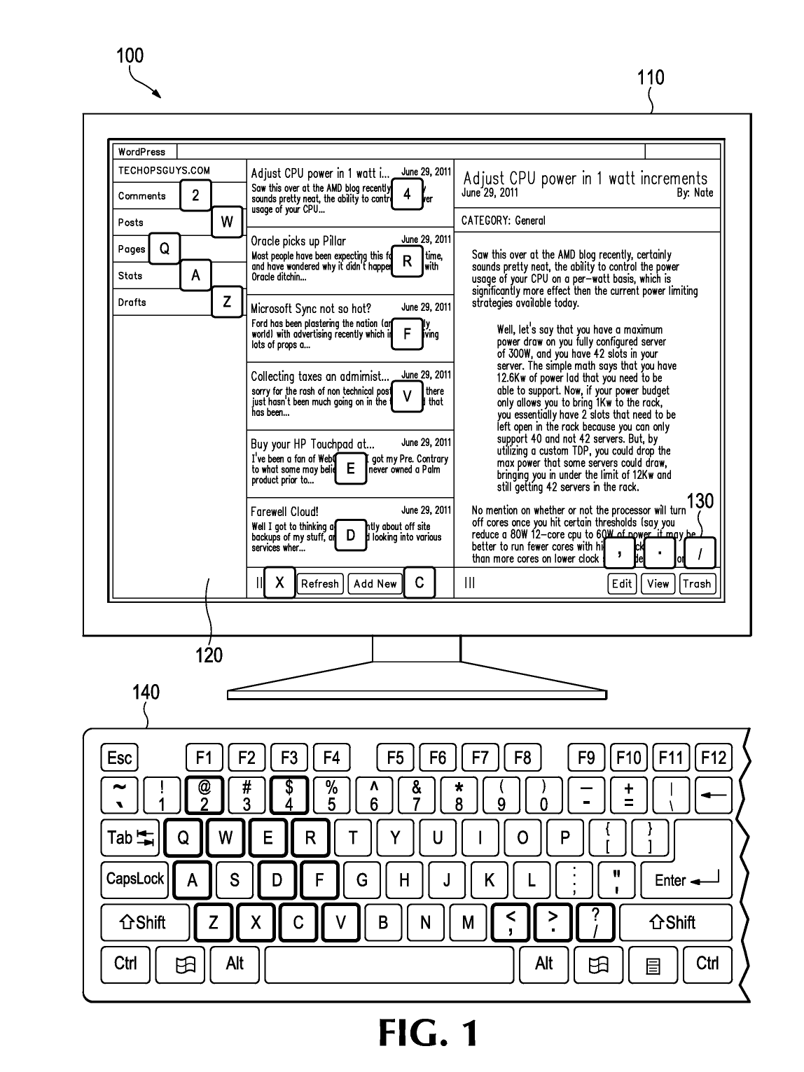

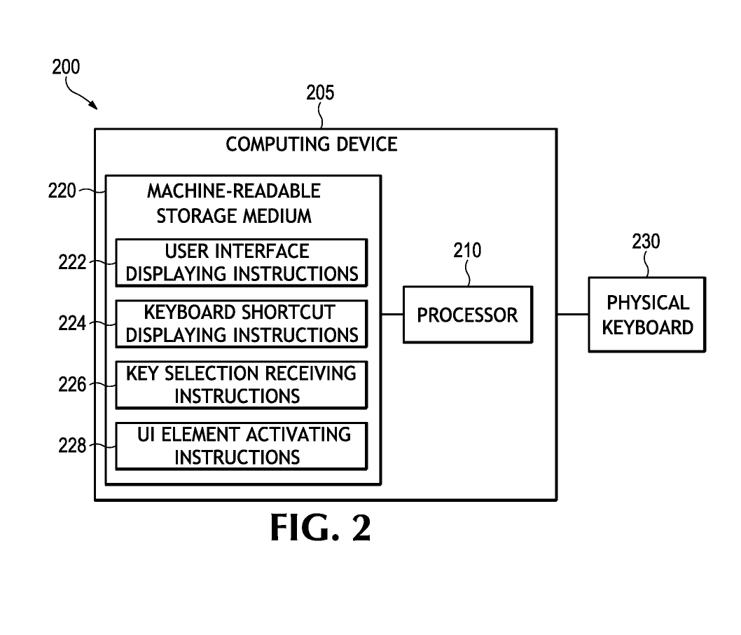

Referring now to the drawings, FIG. 1 is a diagram of an example apparatus 100 for displaying keyboard shortcuts 130 that are spatially mapped to a physical keyboard 140. The following description of FIG. 1 provides an overview of example embodiments. Further implementation details regarding various embodiments are provided below in connection with FIGS. 2 through 6B.

As depicted in FIG. 1, a display 110 outputs a user interface 120 of an application for displaying posts from a blog. The user interface 120 includes a number of selectable UI elements. For example, as shown in the first column, interface 120 allows a user to view comments, posts, pages, stats, and drafts. Similarly, the second column of interface 120 enables a user to select various posts of the blog. Finally, the third column of interface 120 allows a user to view the currently-selected post.

To enable a user to quickly select the interface elements and navigate within the blog application, interface 120 displays a number of keyboard shortcuts 130. As illustrated, the keyboard shortcuts 130 are spatially arranged in a layout corresponding to a layout of physical keyboard 140. In other words, the orientation of the shortcuts with respect to one another in interface 120 is generally the same on keyboard 140.

For example, referring to the first column of UI elements, the keyboard shortcuts are “2”, “W”, “Q”, “A”, and “Z”. Because these UI elements are positioned on the left-hand side of interface 120, the shortcuts correspond to keys that are positioned on the left-hand side of keyboard 140. In addition, the shortcuts in the first column are also arranged vertically in a manner similar to the vertical arrangement of keyboard 140. Thus, because the “Comments” button is above the “Posts” button, the shortcuts (“2” and “W”) correspond to keys that are arranged vertically on keyboard 140. Similarly, because the “Pages”, “Stats”, and “Drafts” buttons are arranged vertically from top to bottom, the shortcuts (“Q”, “A”, and “Z”) correspond to keys that are also arranged on keyboard 140 vertically with respect to one another.

A similar arrangement of shortcuts is applied to the remainder of interface 120. For example, the second column of interface 120 includes shortcuts “4”, “R”, “F”, and “V”, which are arranged vertically in interface 120 and therefore correspond to a column of keyboard 140 (i.e., the column beginning with “4”). Similarly, shortcuts “E”, “D”, and “C” are also arranged vertically in interface 120 and therefore correspond to a portion of another column of keyboard 140. Because the “Refresh” button is located to the left of the “Add New” button, shortcut “X” is used for the “Refresh” button, as the “X” key is positioned to the left of the “C” key on keyboard 140. Finally, the “Edit”, “View”, and “Trash” keys are positioned horizontally with respect to one another and are on the right-hand side of interface 120, so the shortcut keys are the comma key, period key, and forward slash key.

FIG. 2 is a block diagram of an example apparatus 200 including a computing device 205 that displays keyboard shortcuts that are spatially mapped to a physical keyboard 230. As described in further detail below, a computing device 205 may generate and display a number of keyboard shortcuts arranged similarly to the arrangement of keyboard 230. Upon selection of a particular key on keyboard 230 by a user, the computing device 205 may identify the selected shortcut and perform an action on the user interface element located at the position of the selected shortcut.

Computing device 205 may be, for example, a notebook computer, a desktop computer, an all-in-one system, a tablet computing device, a mobile phone, a set-top box, or any other computing device suitable for display of a user interface on a corresponding display device. In the embodiment of FIG. 2, computing device 205 includes a processor 210 and a machine-readable storage medium 220.

Processor 210 may be one or more central processing units (CPUs), semiconductor-based microprocessors, and/or other hardware devices suitable for retrieval and execution of instructions stored in machine-readable storage medium 220. Processor 210 may fetch, decode, and execute instructions 222, 224, 226, 228 to display keyboard shortcuts and respond to activation of the keyboard shortcuts. As an alternative or in addition to retrieving and executing instructions, processor 210 may include one or more electronic circuits that include electronic components for performing the functionality of one or more of instructions 222, 224, 226, 228.

Machine-readable storage medium 220 may be any electronic, magnetic, optical, or other non-transitory physical storage device that contains or stores executable instructions. Thus, machine-readable storage medium 220 may be, for example, Random Access Memory (RAM), an Electrically Erasable Programmable Read-Only Memory (EEPROM), a storage device, an optical disc, and the like. As described in detail below, machine-readable storage medium 220 may be encoded with a series of executable instructions 222, 224, 226, 228 for outputting a user interface including keyboard shortcuts, receiving selection of a keyboard shortcut, and triggering an appropriate action within the UI.

User interface displaying instructions 222 may initially display a user interface including a plurality of selectable UI elements. The user interface may be displayed by the operating system of device 205 or by an application running within the operating system (e.g., a web browser, word processor, photo editor, etc.). Each UI element may be any object capable of receiving input from the user. Thus, to name a few examples, the UI elements may be files, folders, scroll bars, drop-down menus, hyperlinks, or taskbars.

To simplify the task of interacting with the displayed interface, keyboard shortcut displaying instructions 224 may display a plurality of keyboard shortcuts on the user interface. Each of the displayed shortcuts may correspond to a respective key on physical keyboard 230 and may be labeled with the letter(s), number(s), and/or symbol(s) that are present on the corresponding key. To give a few examples, a shortcut labeled with “! 1” may correspond to the key on keyboard 230 labeled with “1” and an exclamation point. Similarly, the shortcut labeled with “Caps Lock” may correspond to the Caps Lock key on keyboard 230.

To increase the usability of the shortcuts, displaying instructions 224 may spatially arrange the keyboard shortcuts in a layout corresponding to the layout of physical keyboard 230. In other words, shortcuts may generally correspond in horizontal and vertical position within the user interface to the horizontal and vertical position of the corresponding key on physical keyboard 230. Thus, shortcuts on the left-hand side of the interface may correspond to keys on the left-hand side of keyboard 230, while shortcuts on the right-hand side of the interface may correspond to keys on the right-hand side of keyboard 230. Similarly, shortcuts on the top of the interface may correspond to keys in the upper portion of keyboard 230, while shortcuts on the bottom of the interface may correspond to keys in the bottom portion of keyboard 230.

In some implementations, displaying instructions 224 may display a single shortcut at the location of each user interface element. FIG. 1, described in detail above, depicts an example of such an interface. In some of these implementations, the shortcuts may be static, such that a UI designer or other individual may assign a shortcut to each user interface element during the design of the user interface. Alternatively, instructions 224 may dynamically assign a shortcut to each UI element prior to display of the shortcuts. In such implementations, instructions 224 may first identify all selectable UI elements within the interface. Displaying instructions 224 may then iterate through each of the UI elements, assigning keyboard shortcuts to each element based on the position of the element within the user interface and further based on the layout of keyboard 230. After obtaining the shortcuts for each UI element, displaying instructions 224 may then output each shortcut on top of or adjacent to the corresponding UI element.

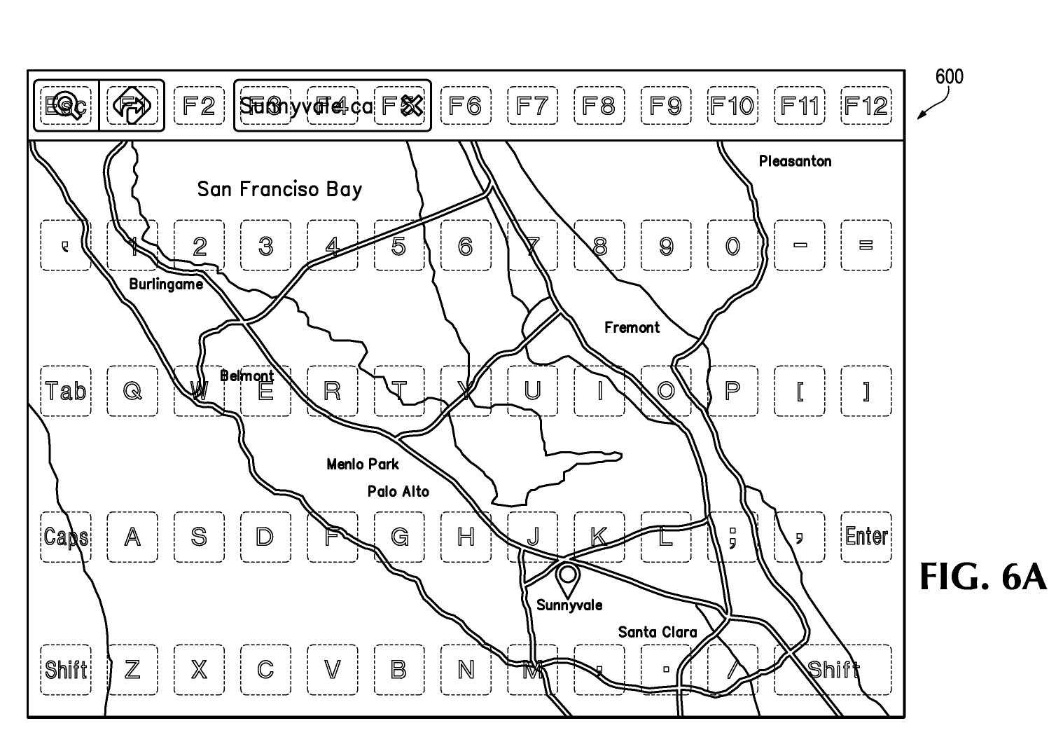

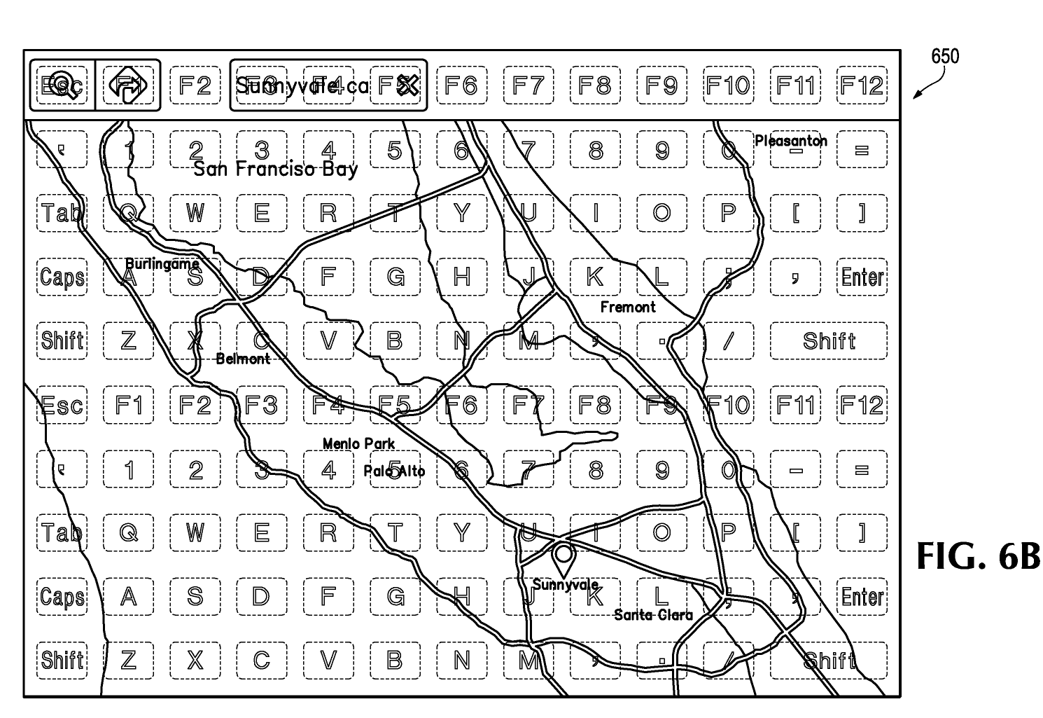

In other implementations, displaying instructions 224 may output a layout of the entire keyboard 230 or a portion thereof overlaid on the user interface. FIGS. 6A & 6B, described in detail below, depict examples of such interfaces. As an example implementation, displaying instructions 224 may output the keyboard shortcuts in a plurality of rows and columns that respectively correspond to rows and columns of the physical keyboard. By displaying the shortcut keys in a grid overlaid on the user interface, displaying instructions 224 allow the user to activate a touch, click, or other input event at the shortcut's location by simply pressing the key displayed on the shortcut.

Regardless of the implementation, displaying instructions 224 may display the shortcut using a number of possible formats. Each shortcut may be included in a rectangle, oval, or other shape or, alternatively, the label may simply be overlaid on top of the interface. Furthermore, various levels of transparency may be applied to each shortcut. For example, the fill color of the shortcuts may be opaque or, alternatively, at least partially transparent so that the underlying interface elements are visible. In addition, in implementations in which the display is 3D-capable, the keyboard shortcuts may be positioned in the same plane as the UI elements or in a different plane, such that the keyboard shortcuts appear to be pop-up notes.

After displaying the keyboard shortcuts, computing device 205 may begin monitoring for keyboard input. Thus, key selection receiving instructions 226 may receive a selection of a particular key on keyboard 230. For example, when the user activates a particular key, receiving instructions 226 may detect a keyboard interrupt and, in response, identify the selected key.

UI element activating instructions 228 may then activate the selectable UI element positioned at the location of the keyboard shortcut that corresponds to the selected key. For example, when the selected shortcut is located at the position of a particular UI element, activating instructions 228 may trigger an action performed in response to selection of the UI element. This may include, for example, activating a function corresponding to a button, scrolling a window based on movement of a scroll bar, opening a new application, following a hyperlink, or performing any other action assigned to the UI element.

In implementations in which each UI element is assigned a corresponding shortcut, activating instructions 228 may directly trigger the corresponding action. Alternatively, in implementations in which the shortcuts are overlaid on the interface without being assigned to particular UI elements, activating instructions 228 may trigger a UI event at the coordinates of the selected keyboard shortcut. For example, in touch-based implementations, activating instructions 228 may generate a touch event that identifies the coordinates of the selected shortcut, such that the operating system (OS) or application receives the touch event and responds appropriately.

Keyboard 230 may be a physical keyboard suitable for receiving typed input from a user and for providing the typed input to computing device 205. Thus, when the user activates a key, such as a key corresponding to a keyboard shortcut, keyboard 230 may provide a signal describing the input to computing device 205. A controller in computing device 205 may then trigger a keyboard interrupt, which, as described above, may be processed by receiving instructions 226. The layout used for keyboard 230 may vary depending on the language and region and, as a result, the shortcuts may also vary depending on these factors. As one specific example, in implementations in which the user interface is presented in English, keyboard 230 may use a conventional QWERTY layout and the shortcuts may be arranged based on the QWERTY layout.

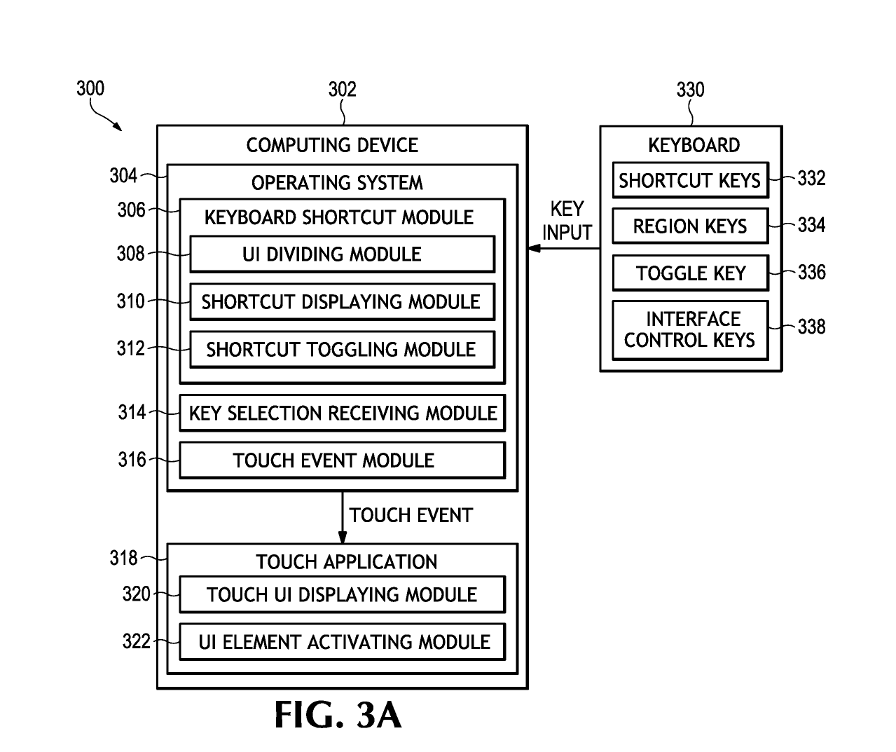

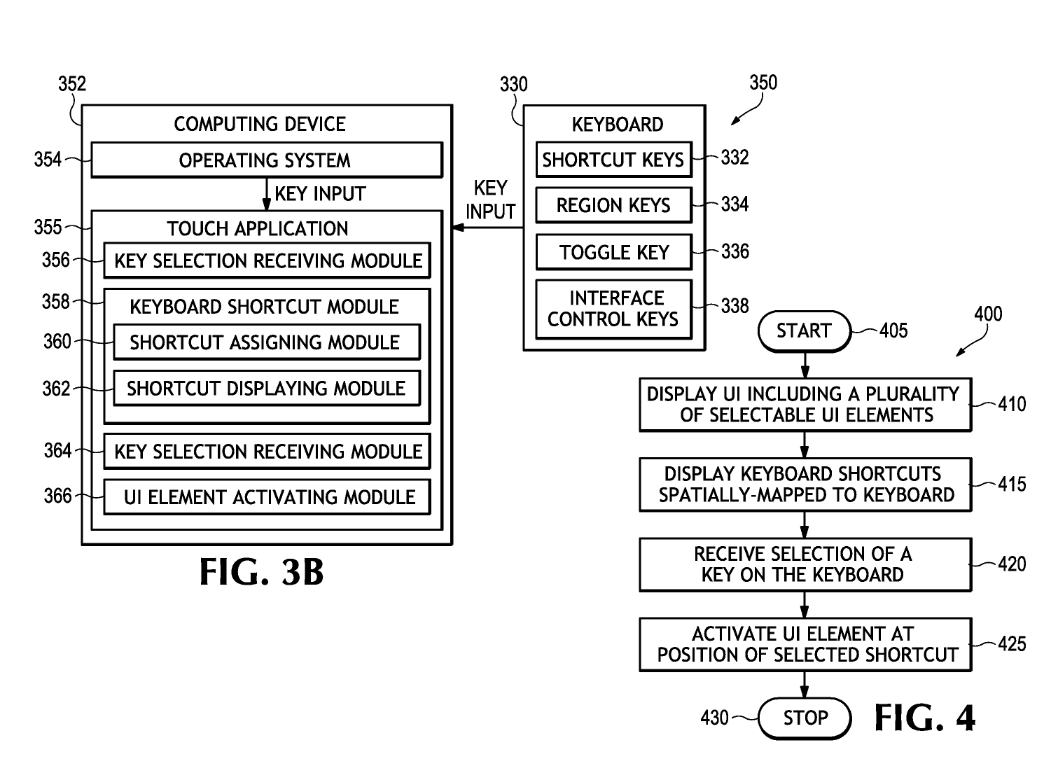

FIG. 3A is a block diagram of an example apparatus 300 for displaying keyboard shortcuts by an operating system 304 of a computing device 302. Apparatus 300 may include a computing device 302 in communication with a keyboard 330. As described further below, operating system 304 displays keyboard shortcuts overlaid on an interface of a touch application 318 and, in response to selection of the shortcuts, transmits touch events to application 318.

As with computing device 205 of FIG. 2, computing device 302 may be any computing device suitable for display of a user interface. As illustrated, computing device 302 may include a number of modules 306-316, 320, 322 for providing the keyboard shortcut functionality described herein. Each of the modules may include a series of instructions encoded on a machine-readable storage medium and executable by a processor of computing device 302. In addition or as an alternative, each module may include one or more hardware devices including electronic circuitry for implementing the functionality described below.

Operating system 304 may include a series of instructions for managing the hardware resources of computing device 302 and providing an interface to the hardware to applications running in OS 304, such as touch application 318. In the implementation of FIG. 3A, OS 304 includes a series of modules 306-316 for displaying keyboard shortcuts and responding to user selection of the shortcuts.

Keyboard shortcut module 306 may manage the process for generating and displaying keyboard shortcuts that are overlaid on the interfaces of applications executing within OS 304, such as touch application 318. Thus, keyboard shortcut module 306 may include UI dividing module 308, shortcut displaying module 310, and shortcut toggling module 312. As detailed below, because OS 304 is generally unaware of the touch targets within touch application 318, modules 308, 310, 312 may be configured to generate and display a grid of touch shortcuts, such as the grids depicted in FIGS. 6A & 6B.

UI dividing module 308 may include functionality for determining whether to divide the available display area into multiple regions in which the keyboard shortcuts are separately mapped to keyboard 330. An example of such an arrangement is depicted in FIG. 6B. As one example implementation, UI dividing module 308 may initially determine the number of areas to map to keyboard 330 based on the resolution of the display of computing device 302, the number of touch targets within the interface, or any other information indicating a required level of precision. UI dividing module 308 may then divide the available display area into regions of generally equal size (e.g., two rectangles, four rectangles that form a 2×2 grid, etc.). In some implementations, each of the generated regions may be roughly proportional to the area of keyboard 330 to which the keyboard shortcuts will be mapped. For example, if the entire keyboard will be used, each region may be a rectangle with a length about 2 to 3 times the width.

Shortcut displaying module 310 may then separately map the shortcuts in each generated region to the layout of keyboard 330. For example, for each region, displaying module 310 may generate a plurality of rows and columns of shortcuts that are arranged to correspond to the rows and columns of keyboard 330. In other words, the shortcuts in each region may be arranged based on the physical arrangement of the keys on keyboard 330.

After generating the shortcuts in a grid pattern, shortcut displaying module 310 may then output the shortcuts when shortcut toggling module 312 indicates that the user has enabled the display of shortcuts. More specifically, shortcut toggling module 312 may detect user selection of toggle key 336 and communicate the selection to displaying module 310, such that the user may toggle between a first mode in which shortcuts are displayed and a second mode in which shortcuts are not displayed.

Subsequent to display of the shortcut keys, key selection receiving module 314 may receive a selection of a particular shortcut key 332 from the user. In addition, in implementations in which shortcut displaying module 310 has displayed multiple regions of shortcuts, receiving module 314 may also receive a selection of a region key 334 that specifies in which region to activate the keyboard shortcut. For example, when the interface is divided into two regions of keyboard shortcuts, the user may select one key (e.g., “CTRL”) for the first region and a second key (e.g., “ALT”) for the second region. In this example, if the user inputs CTRL+A, the selection would apply to the “A” shortcut in the first region. On the other hand, if the user inputs ALT+A, the selection would apply to the “A” shortcut in the second region.

Finally, touch event module 316 may generate a touch event identifying the position of the selected keyboard shortcut within the user interface and make the event available to touch application 318. For example, OS 304 may define an Application Programming Interface (API) that specifies a set of rules for communicating events to applications. In this instance, touch event module 316 may generate an API message that identifies the coordinates of the selected keyboard shortcut as the location of a touch event, such as a tap or gesture. As one specific example, when OS 304 is Microsoft Windows, the touch event may be a WM_TOUCH message. After generating the touch event, touch event module 316 may provide the touch event to touch application 318.

Touch application 318 may be any application executing within OS 304 that provides a user interface supporting the receipt of touch events. Thus, touch application 318 may be a web browser, word processor, game, media player, or any other application. Touch application 318 may include a touch UI displaying module 320 and a UI element activating module 322.

Touch UI displaying module 320 may initially output the touch user interface within OS 304. As detailed above, OS 304 may then output the keyboard shortcuts overlaid on the interface of application 318. In response to receipt of a touch event from OS 304, UI element activating module 322 may process the received touch event. In particular, UI element activating module 322 may determine whether there is a user interface element located at the coordinates described in the touch event and, if so, perform a corresponding action on the UI element. For example, activating module 322 may perform a function triggered by a button, scroll a window controlled by a scroll bar, follow a hyperlink, or perform any other action controlled by the selected UI element.

Keyboard 330 may be a physical keyboard including a plurality of selectable keys. As detailed above, shortcut keys 332 may be assigned to keyboard shortcuts displayed by displaying module 310. Region keys 334 may allow a user to identify a region in which to activate the keyboard shortcut corresponding to a selected shortcut key 332. Additionally, toggle key 336 may allow the user to toggle the display of the keyboard shortcuts.

In some implementations, interface control keys 338 may allow a user to perform other touch functions using the keyboard. For example, control keys 338 may be dedicated to scrolling, zooming, flicking, or other functionality for controlling the touch-enabled interface displayed by application 318. For example, the arrow keys, numeric keypad, or other hot keys may be reserved for these functions, such that, in combination with shortcut keys 332, the user may fully control the touch interface using only keyboard 330. The functionality corresponding to each interface control key 338 may be implemented by OS 304 or by touch application 318 depending on the particular implementation.

FIG. 3B is a block diagram of an example apparatus 350 for displaying keyboard shortcuts by an application 355 executing on a computing device 352. Apparatus 350 may include a computing device 352 in communication with a keyboard 330. As described further below, touch application 355 displays keyboard shortcuts for each UI element and, in response to selection of a shortcut, activates the corresponding UI element.

As with computing device 302 of FIG. 3A, computing device 352 may be any computing device suitable for display of a user interface. As illustrated, computing device 352 may include a number of modules 356-366 for providing the keyboard shortcut functionality described herein. Each of the modules may include a series of instructions encoded on a machine-readable storage medium and executable by a processor of computing device 352. In addition or as an alternative, each module may include one or more hardware devices including electronic circuitry for implementing the functionality described below.

As with operating system 304 of FIG. 3A, operating system 354 may include a series of instructions for managing the hardware resources of computing device 352 and providing an interface to the hardware to applications running in OS 354. In the implementation of FIG. 3B, rather than providing touch events to touch application 355, OS 354 provides data describing key input received from keyboard 330. As detailed below, key selection receiving module 364 of touch application 355 may then process the key input accordingly.

Touch application 355 may be any application executing within OS 354 that provides a user interface supporting the receipt of touch events. In the implementation of FIG. 3B, touch application 355 includes a series of modules 356-366 for displaying keyboard shortcuts and responding to user selection of the shortcuts.

Touch UI displaying module 356 may initially output the touch user interface within OS 354. The touch user interface may include a number of elements with which the user may interact using touch. For example, the displayed touch UI may include selectable buttons, scroll bars, hyperlinks, or any other elements that receive data or perform an action in response to user input.

Keyboard shortcut module 358 may then manage the process for generating and displaying keyboard shortcuts overlaid on the user interface. In the implementation of FIG. 3B, touch application 355 may be aware of the various UI elements in the displayed interface and, as a result, modules 360, 362 of keyboard shortcut module 358 may display a single keyboard shortcut for each of the UI elements. In other words, the keyboard shortcuts may have a one-to-one correspondence with the UI elements.

Shortcut assigning module 360 may manage the process for generating a keyboard shortcut for each UI element in the user interface. In some implementations, shortcut assigning module 360 may obtain shortcuts statically assigned to each user interface element based on the layout of keyboard 330 by an interface designer, software engineer, or other individual. In other implementations, shortcut assigning module 360 may automatically assign keyboard shortcuts to each of the UI elements in the interface. For example, shortcut assigning module 360 may first identify all selectable user interface elements in the interface. Shortcut assigning module 360 may then iterate through each of the identified elements to assign a keyboard shortcut to each element based on the position of the element within the user interface as compared to the layout of keyboard 330. For example, shortcut assigning module 360 may proceed through the UI elements row-by-row and assign keyboard shortcuts within a given row of keys of keyboard 330 based on the horizontal position of each element in the interface. As another example, shortcut assigning module 360 may proceed through the UI elements column-by-column and assign keyboard shortcuts within a given column of keys of keyboard 330 based on the vertical position of each element in the interface.

As with keyboard shortcut module 306 of FIG. 3A, keyboard shortcut module 358 may divide the UI into regions of keyboard shortcuts, such that the shortcuts of each region are mapped separately to the layout of keyboard 330. For example, shortcut assigning module 360 may identify a number of regions within the displayed interface and separately perform the assigning procedure described above for each region.

After shortcut assigning module 360 generates the shortcuts, shortcut displaying module 362 may then display each keyboard shortcut at a position of the corresponding UI element. For example, shortcut displaying module 362 may display each shortcut adjacent to or on top of the corresponding UI element. As with keyboard shortcut module 306 of FIG. 3A, displaying module 362 may also toggle display of the shortcuts based on user selection of toggle key 336.

After display of the keyboard shortcuts, key selection receiving module 364 may then begin monitoring for user input indicating a selection of a particular keyboard shortcut. For example, receiving module 364 may receive data describing a selected key from OS 354 and determine whether the selected key corresponds to a particular shortcut key 332. Key selection receiving module 364 may also receive a selection of a region key 334 when multiple regions of shortcuts are displayed.

In response to a determination that a particular keyboard shortcut has been activated, UI element activating module 366 may then activate the UI element corresponding to the selected keyboard shortcut. For example, activating module 366 may perform a function triggered by a button, scroll a window controlled by a scroll bar, follow a hyperlink, or perform any other action controlled by the selected UI element.

FIG. 4 is a flowchart of an example method 400 for providing keyboard shortcuts and responding to user selection of the keyboard shortcuts. Although execution of method 400 is described below with reference to apparatus 200 of FIG. 2, other suitable devices for execution of method 400 will be apparent to those of skill in the art (e.g., apparatus 300, 350). Method 400 may be implemented in the form of executable instructions stored on a machine-readable storage medium, such as storage medium 220, and/or in the form of electronic circuitry.

Method 400 may start in block 405 and continue to block 410, where computing device 205 may display a UI including a plurality of selectable UI elements. For example, the UI may be an interface of an application, such as a web browser, word processor, game, media player, and the like. Each UI element may be any object that receives input from a user, which, in some cases, may be touch input.

After display of the interface, method 400 may continue to block 415, where computing device 205 may display keyboard shortcuts that are spatially mapped to keyboard 230. In other words, to enable fast selection of the shortcuts, computing device 205 may arrange the keyboard shortcuts in a layout corresponding to the layout of the keyboard 230.

Next, in block 420, computing device 205 may receive a selection of a particular key on the keyboard that corresponds to a displayed keyboard shortcut. Finally, in block 425, computing device 205 may activate the UI element located at the position of the selected shortcut. Method 400 may then continue to block 430, where method 400 may stop.

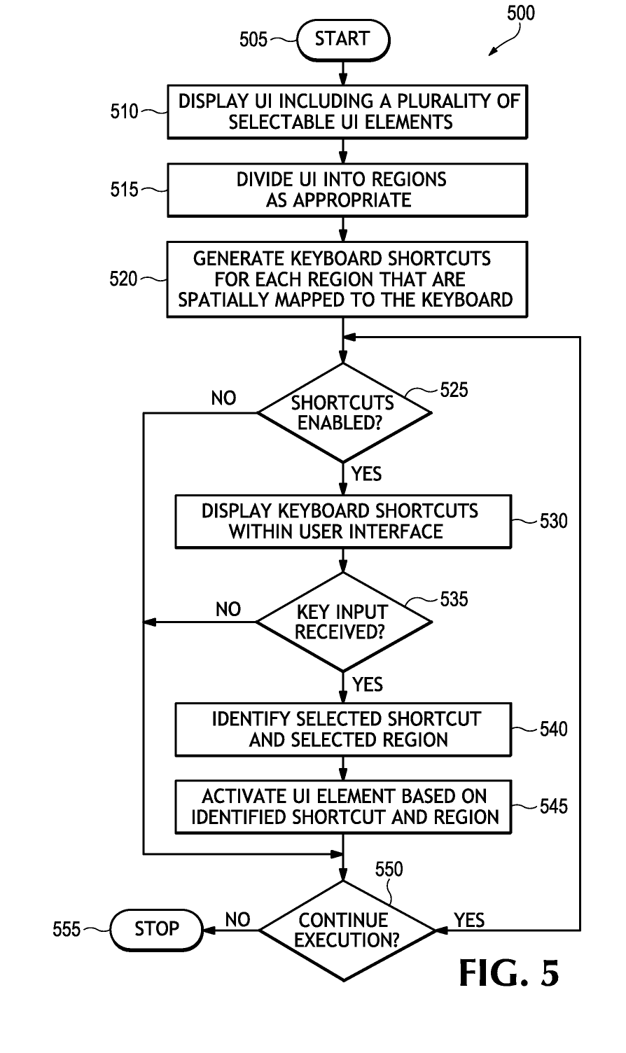

FIG. 5 is a flowchart of an example method 500 for providing keyboard shortcuts in multiple regions of an interface and for responding to user selection of the keyboard shortcuts. Although execution of method 500 is described below with reference to apparatus 300, 350 of FIGS. 3A & 3B, other suitable devices for execution of method 500 will be apparent to those of skill in the art. Method 500 may be implemented in the form of executable instructions stored on a machine-readable storage medium and/or in the form of electronic circuitry.

Method 500 may start in block 505 and continue to block 510, where computing device 302, 352 may display a UI including a plurality of selectable UI elements. Next, in block 515, computing device 302, 352 may determine whether to divide the UI into multiple regions, where each region will include keyboard shortcuts separately mapped to the keyboard 330. In making this determination, computing device 302, 352 may consider, for example, the resolution of the display, the number of UI elements in the interface, or any other factors indicating a level of precision required for the keyboard shortcuts. In block 520, computing device 302, 352 may then generate keyboard shortcuts for each region, such that the shortcuts in each region are spatially mapped to the physical arrangement of the keys on keyboard 330.

In block 525, computing device 302, 352 may determine whether keyboard shortcuts are currently enabled based on toggle key 336. When keyboard shortcuts are not currently enabled, method 500 may skip to block 550, described in further detail below. Alternatively, if keyboard shortcuts are currently enabled, method 500 may continue to block 530, where computing device 302, 352 may display the keyboard shortcuts overlaid on the interface displayed in block 510. For example, as described in connection with FIG. 3A and depicted in FIGS. 6A & 6B, the operating system 304 of computing device 302 may display the shortcuts in an arrangement of rows and columns. Alternatively, as described in connection with FIG. 3B and depicted in FIG. 1, a touch application 355 executing on computing device 352 may display the shortcuts such that a single shortcut corresponds to each UI element.

After display of the shortcuts in block 530, method 500 may continue to block 535, where computing device 302, 352 may determine whether key input has been received from keyboard 330. If no input has been received, method 500 may skip to block 550, described below. Otherwise, method 500 may continue to block 540, where computing device 302, 352 may identify the selected shortcut key 332 and, if applicable, a region key 334 specifying the region in which the shortcut is located.

Next, in block 545, computing device 302, 352 may activate the UI element located at the position of the selected shortcut key. In the implementation of FIG. 3A, operating system 304 may generate a touch event and provide the touch event to touch application 318. Touch application 318 may then activate the UI element located at the coordinates identified in the touch event. Alternatively, in the implementation of FIG. 3B, touch application 318 may directly receive the key input and, in response, activate the UI element corresponding to the selected keyboard shortcut. Method 500 may then continue to block 550.

In block 550, computing device 302, 352 may determine whether to proceed with execution of the method. For example, provided that computing device 302, 352 remains powered on and the touch software is executing, method 500 may return to block 525, where computing device 302, 352 may continue the process for displaying keyboard shortcuts. Alternatively, method 500 may proceed to block 555, where method 500 may stop.

FIG. 6A is a diagram of an example user interface 600 including keyboard shortcuts arranged in rows and columns that correspond to a physical keyboard. User interface 600 may correspond, for example, to an arrangement of keyboard shortcuts displayed by operating system 304 of FIG. 3A.

As illustrated in FIG. 6A, a grid of keyboard shortcuts arranged in a series of rows and columns is overlaid on top of a user interface of a map application. As detailed above, by selecting a key on the keyboard corresponding to the displayed keyboard shortcut, the user may activate a touch event at the position of the displayed shortcut and the operating system may provide details of the touch event to the map application. In response, the map application may respond to the touch event.

For example, pressing the “ESC” key may trigger a touch event at the location of the magnifying glass icon. In response, the map application may receive the touch event from the operating system, determine that the magnifying glass has been selected, and take an appropriate action, such as displaying a pop-up menu for controlling a zoom level of the map. As another example, pressing the “TAB” key may trigger a touch event at the corresponding coordinates of the map. In response, the map application may receive the touch event, determine that the map has been selected at the coordinates of the “TAB” shortcut, and take an appropriate action, such as zooming in on the map at the position of the “TAB” shortcut.

FIG. 6B is a diagram of an example user interface 650 including keyboard shortcuts arranged within two regions in rows and columns that correspond to a physical keyboard. User interface 650 may correspond, for example, to an arrangement of keyboard shortcuts displayed by operating system 304 of FIG. 3A.

In contrast to interface 600 of FIG. 6A, interface 650 includes two regions, each of which includes shortcuts separately mapped to the layout of the keyboard. Thus, in this example, a user may also provide a region key in connection with selection of a particular shortcut. For example, suppose that “CTRL” is used as the region key for the top region of shortcuts, while “ALT” is used as the region key for the bottom region of shortcuts. In this case, user selection of CTRL+ESC would trigger a touch event at the location of the magnifying glass icon. On the other hand, user selection of ALT+ESC would trigger a touch event at the coordinates of the lower ESC shortcut. In either case, the touch application may receive a touch event from the operating system identifying the coordinates of the selected shortcut and trigger an appropriate action in response to the touch event.

The foregoing disclosure describes a number of example embodiments for displaying keyboard shortcuts that are arranged similarly to the physical layout of the keyboard. In this manner, the embodiments disclosed herein enable a user to efficiently provide input to a user interface, as the user may quickly trigger shortcuts based on their location on the screen. Furthermore, in touch implementations, the user may control a touch interface using the keyboard, thereby minimizing the need to actually touch the display. Additional embodiments and advantages of such embodiments will be apparent to those of skill in the art upon reading and understanding the foregoing description.

We claim:

1. A computing device for providing keyboard shortcuts, the computing device comprising:
a processor to:
display a user interface (UI) including a plurality of selectable UI elements,
display a plurality of keyboard shortcuts on the user interface, wherein each keyboard shortcut corresponds to a respective key on a physical keyboard and the plurality of keyboard shortcuts are spatially arranged in a layout corresponding to a layout of the physical keyboard,
receive a selection of a particular key on the physical keyboard, and
activate the selectable UI element positioned at a location of the keyboard shortcut corresponding to the selected key.

2. The computing device of claim 1, wherein:
the UI elements are touch interface elements selectable based on receipt of a touch command, and
the processor is additionally to trigger a touch event upon receipt of the selection of the particular key.

3. The computing device of claim 1, wherein the processor is additionally to:
toggle between a first mode and a second mode in response to user selection of a shortcut toggle key, wherein the keyboard shortcuts are displayed in the first mode and not displayed in the second mode.

4. The computing device of claim 1, wherein the processor is additionally to:
identify the plurality of selectable UI elements in the user interface prior to display of the keyboard shortcuts, and
assign a keyboard shortcut to each UI element based on a position of the UI element within the user interface.

5. The computing device of claim 1, wherein, to display the plurality of keyboard shortcuts, the processor is configured to:
display the keyboard shortcuts in a plurality of rows and columns, wherein the rows and columns of the keyboard shortcuts respectively correspond to rows and columns of the physical keyboard.

6. The computing device of claim 1, wherein, to display the plurality of keyboard shortcuts, the processor is configured to:
divide the user interface into a plurality of regions, and
display keyboard shortcuts within each of the plurality of regions, wherein the shortcuts in each region are spatially mapped to the layout of the physical keyboard.

7. The computing device of claim 6, wherein the processor is additionally to:
receive a selection of a region selection key in addition to the selection of the particular key, the region selection key specifying in which region to activate the keyboard shortcut corresponding to the selected key.

8. The computing device of claim 1, wherein, to display the plurality of keyboard shortcuts, the processor is configured to:
perform a touch function on the displayed user interface in response to user selection of a touch interface control key, wherein the touch function comprises zooming, scrolling, or flicking.

9. A non-transitory machine-readable storage medium encoded with instructions executable by a processor of a computing device for providing keyboard shortcuts, the machine-readable storage medium comprising:
instructions for displaying a plurality of keyboard shortcuts overlaid on a user interface including a plurality of selectable UI elements, wherein:
each keyboard shortcut corresponds to a respective key on a physical keyboard, and
the plurality of keyboard shortcuts are arranged based on a physical arrangement of the keys on the physical keyboard;
instructions for receiving a selection of a particular key on the physical keyboard; and
instructions for activating the selectable UI element positioned at a location of the keyboard shortcut corresponding to the selected key.

10. The machine-readable storage medium of claim 9, wherein:
an operating system of the computing device comprises the instructions for displaying the keyboard shortcuts, and
the operating system further comprises:
instructions for generating a touch event identifying a position of the selected keyboard shortcut within the user interface, and
instructions for providing the touch event to an application that displays the user interface.

11. The machine-readable storage medium of claim 10, wherein:
the instructions for displaying included in the operating system are configured to display the keyboard shortcuts in a plurality of rows and columns, and
the rows and columns of the keyboard shortcuts respectively correspond to rows and columns of the physical keyboard.

12. The machine-readable storage medium of claim 9, wherein:
the instructions for displaying the keyboard shortcuts are included in an application that displays the user interface,
each keyboard shortcut is pre-assigned to a corresponding UI element, and
the instructions for displaying are configured to display each keyboard shortcut at a position of the corresponding UI element.

13. A method for providing keyboard shortcuts, the method comprising:
displaying a touch user interface (UI) including a plurality of UI elements selectable by touch;
displaying a plurality of keyboard shortcuts on the touch user interface, wherein each of the plurality of keyboard shortcuts corresponds to a respective key on the physical keyboard and is positioned within the user interface according to a location of the corresponding key on the physical keyboard;
receiving a selection of a particular key on the physical keyboard; and
performing an action on the UI element positioned at a location of the particular keyboard shortcut corresponding to the selected key.

14. The method of claim 13, wherein displaying the keyboard shortcuts comprises:
displaying the keyboard shortcuts in a plurality of rows and columns, wherein the rows and columns of the keyboard shortcuts respectively correspond to rows and columns of the physical keyboard.

15. The method of claim 13, wherein displaying the keyboard shortcuts comprises:
dividing the user interface into a plurality of regions, and
displaying keyboard shortcuts within each of the plurality of regions, wherein the shortcuts in each region are spatially mapped to a layout of the physical keyboard.
